(19) United States
(12) Patent Application Publication
(10) Pub. No.: US 2008/0126219 A1
(43) Pub. Date: May 29, 2008

(54) SYSTEM FOR AND METHOD FOR ORGANIZING AND DISTRIBUTING AUDIO OR AUDIOVISUAL INFORMATION

(75) Inventor: Charles M. Hengel, Woodland, MN (US)

Correspondence Address: SCHWEGMAN, LUNDBERG & WOESSNER, P.A., P.O. BOX 2938, MINNEAPOLIS, MN, 55402, US

(73) Assignee: MA Capital LLLP

(21) Appl. No.: 11/937,072

(22) Filed: Nov. 8, 2007

Related U.S. Application Data
(60) Provisional application No. 60/857,618, filed on Nov. 8, 2006.

(51) Int. Cl. G06Q 30/00

(52) U.S. Cl. 705/26

(57) ABSTRACT

This document describes, among other things, according to one example embodiment, there is provided methods and systems for managing and organizing audio or audiovisual content, and for producing audio or audiovisual compilations from the content. According to one example embodiment, there is provided a content server system that receives content and related information may be uploaded or entered and managed from client computers. The server system may comprise one or more servers and storage devices, and software, wherein the servers may be proximate to one another or located remotely from one another. Content may be audio or audiovisual content. According to one example embodiment, the content is audio content generated by a radio station, wherein the content may have been broadcast by the radio station. Information relating to the content is uploaded or entered from a client computer, for example a client computer at a radio station. The content is then advertised by the radio station and sold through an operation run by a party other than the radio station.

### CROSS REFERENCE TO RELATED APPLICATIONS

This patent application claims the benefit of priority, under 35 U.S.C. Section 119(e), to U.S. Provisional Patent Application Ser. No. 60/857,618, entitled “SYSTEM AND METHOD FOR ORGANIZING AND DISTRIBUTING AUDIO INFORMATION,” filed on Nov. 8, 2006, the contents of which are hereby incorporated by reference in their entirety.

### TECHNICAL FIELD

This patent document pertains generally to software systems and methods, and more particularly to systems and methods for organizing and distributing audio information.

### BACKGROUND

Media stations include entities that broadcast programs and advertisements, such as radio and television stations. Such stations often have audio or audiovisual content that requires management and that can be packaged and published.

### BRIEF DESCRIPTION OF THE DRAWINGS

FIG. 1 illustrates a functional block diagram of a content production system in accordance with an example embodiment.

FIG. 2 illustrates a web-based user interface supported by the server system in accordance with an example embodiment.

FIG. 3 illustrates a web-based user interface supported by the server system used to assemble a volume (compilation) for sale and distribution in accordance with an example embodiment.

FIG. 4 illustrates a method 400 for using the user interface of FIG. 2 in accordance with an example embodiment.

FIG. 5 illustrates a web-based user interface supported by the server system used to display products and related volumes and various related information in accordance with an example embodiment.

FIG. 6 illustrates a system user structure for the system in accordance with an example embodiment.

FIG. 7 illustrates a method and system for producing and distributing content in accordance with an example embodiment.

FIG. 8 illustrates a sponsorship arrangement in accordance with an example embodiment in accordance with an example embodiment.

FIG. 9 illustrates a system for producing and distributing content in accordance with an example embodiment.

FIG. 10 illustrates a method of coordinating the production and distribution of content between a radio station organization and a third party in accordance with an example embodiment.

FIG. 11 illustrates a system for producing and distributing content in accordance with an example embodiment.

FIG. 12 illustrates a system for producing and distributing content in accordance with an example embodiment.

FIG. 13 illustrates a method of coordinating the production and distribution of content between a radio station organization and a third party in accordance with an example embodiment.

FIG. 14 illustrates a web-based user interface supported by the server system used to display a high-level, multi-station view of products and related volumes and related information

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

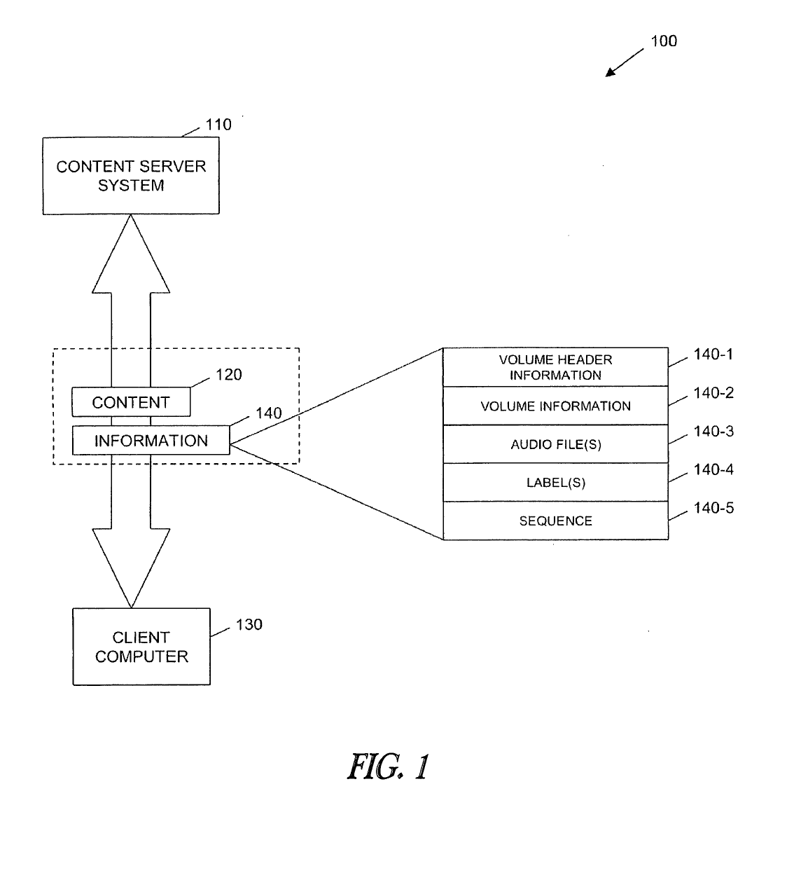

According to one example embodiment, there is provided methods and systems for managing and organizing audio or audiovisual content, and for producing audio or audiovisual compilations from the content. According to one example embodiment, as illustrated in FIG. 1, a system 100 includes a content server system 110 that receives content 120 and related information may be uploaded or entered and managed from client computers 130. Server system 110 may comprise one or more servers and storage devices, and software, wherein the servers may be proximate to one another or located remotely from one another. Content 120 may be audio or audiovisual content. According to one example embodiment, the content is audio content generated by a radio station, wherein the content may have been broadcast by the radio station. Information 140 relating to the content is uploaded or entered from a client computer, for example a client computer at a radio station:
1. Volume header information 140-1 and volume information 140-2 that may be used to call attention to favorite tracks and/or station events.
2. Audio files 140-3 (for example in mp3 file format) that may be used to form tracks of a compilation of audio content, and labels 140-4 (for example title & artists) for each track.
3. A sequence 140-5 for the tracks as desired for production on a CD and to appear on a CD track listing.
   Information 140, accordingly, may be used to produce compilations that may be termed “volumes”, wherein the volumes are burned onto CDs or other media for distribution to customers, or may be offered on-line for downloading to a customer computer over a wide area network such as the Internet or other such network.

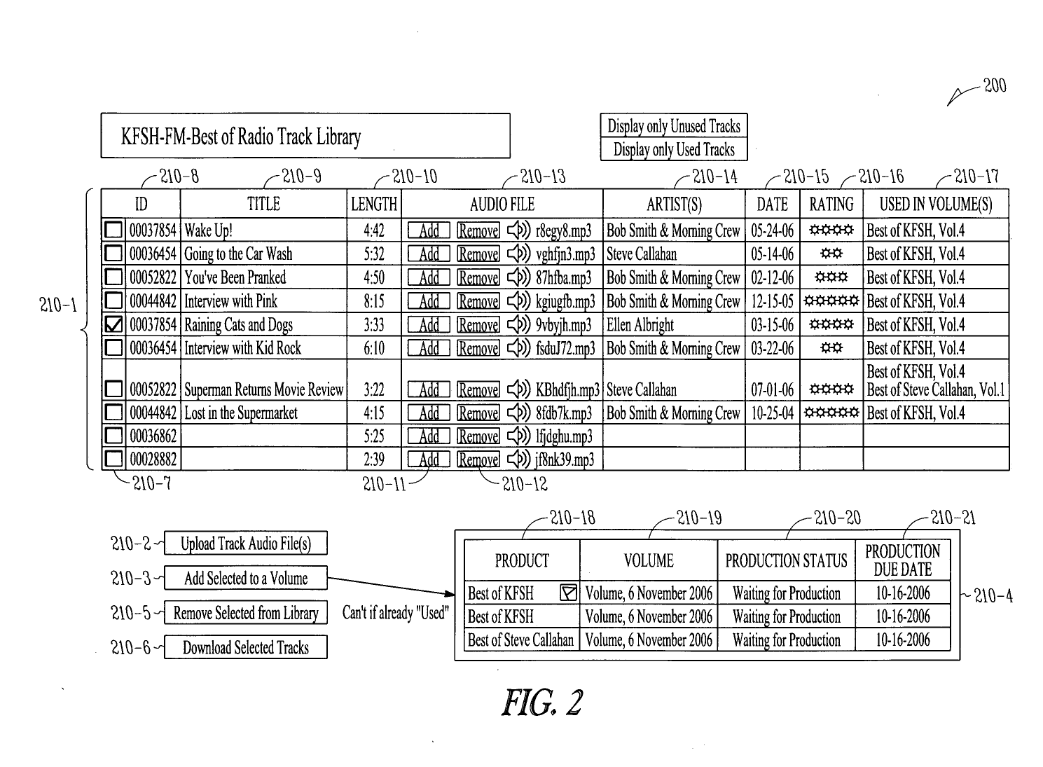

Referring now to FIG. 2, there is illustrated one example embodiment of a web-based user interface 200 supported by the server system 110. User interface 200 may be used to build or display a library of audio tracks, in this example tracks of broadcast radio audio. These tracks may be to prepare a “best of” compilation, for example, or any other type of compilation. This web-based interface includes:
1. An upload track audio file button 210-2 to add a track to the list of tracks 210-1.
2. An add selected to a volume button 210-3 to add a track to a volume (also referred to as a compilation)—this button will give you a pick list of volumes 210-4 to choose from.
3. A remove selected from library button 210-5 to remove a track from the library, but only if the track is not already assigned to a volume.
4. A download selected track button 210-6 to allow a uses to download a track to their computer.
5. A check field 210-7 used to select one of tracks 210-1.
6. A track ID field 210-8 to display a track number, wherein the track number may be automatically generated by system 110.
7. A track title field 210-9 to enter and/or display a track title.
8. A track length field 210-10 to display the length of a track, wherein the length of the track is determined by system 110 by inspecting the associated audio file uploaded for the track.
9. An add button 210-11 to use to upload an audio file for a track 210-1.
10. A remove button 210-12 to use to remove an audio file for a track 210-1.
11. An audio file field 210-13 that displays the name of an audio file uploaded to system 110.
12. An artist(s) field 210-14 to enter and display the artists on the track.
13. A date field 210-15 to use to enter and display a date of the track.
14. A rating field 210-16 to use to rate the quality of the track.
15. A used in volume field 210-17 to use to enter and display the name of a compilation, also referred to as a volume in this instance, which the track is used in.
16. A product name field 210-18 to use to enter and/or display a name of a product with which a volume or compilation is associated with.
17. A volume field 210-19 to use to enter and/or display a volume associated with the product.
18. A production status field 210-20 to use to indicate the status of the volume, for example indicating it is waiting for production or that it is in production, or other status. Other available production status states may include production past due, production delivered, ready to sell & ship, on sale & shipping, or archived.
19. A production due date field 210-21 used to indicate the date the production of the volume is due.

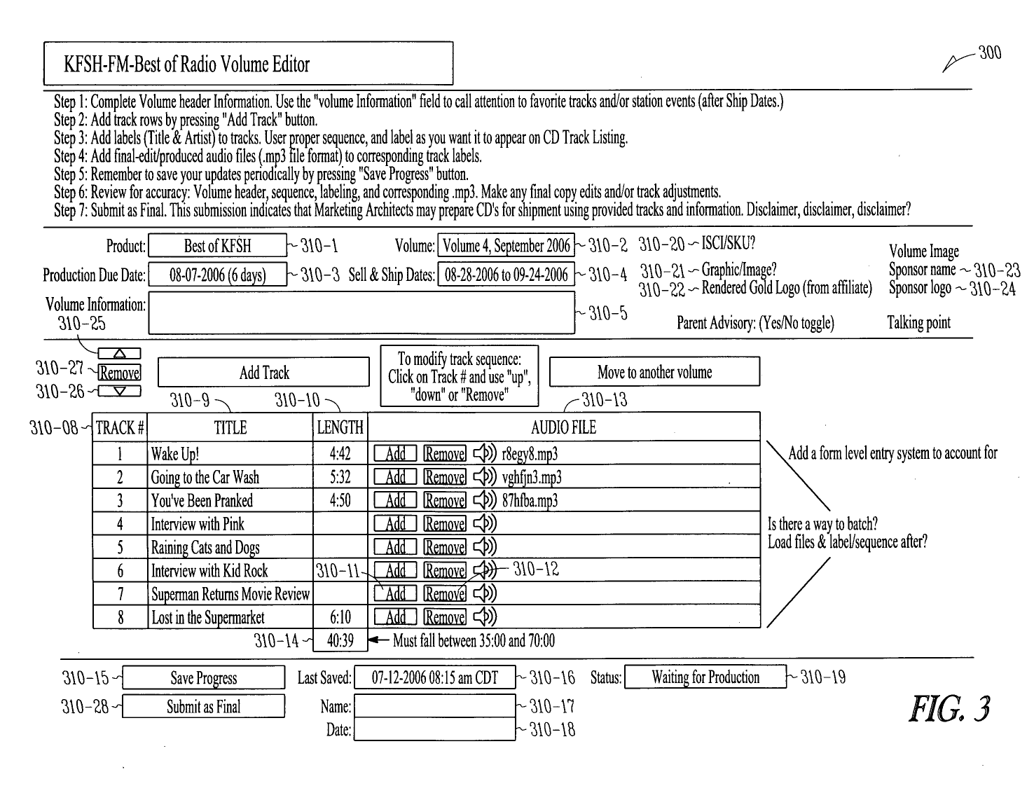

Referring now to FIG. 3, there is illustrated one example embodiment of a web-based user interface 300 supported by the server system 110, wherein the web-based interface is used to assemble a volume (compilation) for sale and distribution, and includes the following features:
1. A product field 310-1 to enter and/or display a product name.
2. A volume field 310-2 to enter and/or display a volume name or label.
3. A production due date field 310-3 to enter and/or display a production due date.
4. A sell and ship dates field 310-4 to enter and/or display volume sell and ship dates.
5. A volume information field 310-5 to enter and/or display volume information.
6. An add track button 310-6 to add a track to the list of tracks 310-7.
7. A track number field 310-8 to display a track number, wherein the track number may be automatically generated by system 110.
8. A track title field 310-9 to enter and/or display a track title.
9. A track length field 310-10 to display the length of a track, wherein the length of the track is determined by system 110 by inspecting the associated audio file uploaded for the track.
10. An add button 310-11 to use to upload an audio file for a track 310-7.
11. A remove button 310-12 to use to remove an audio file for a track 310-7.
12. An audio file field 310-13 that displays the name of an audio file uploaded to system 110.
13. A total length of tracks field 310-14 that shows the total track lengths of all tracks uploaded for the volume.
14. A save progress button 310-15 that saves all currently entered data in system 110.
15. A last save field 310-16 that indicates the last time the save progress button 310-15 was successfully performed.
16. A name field 310-17 to use to enter and/or display a name of an individual entering data into the interface.
17. A date field 310-18 to use to enter and/or display a date associated with the entry of data into the interface.
18. A status field 310-19 to use to indicate the status of the volume, for example indicating it is waiting for production or that it is in production, or other status.
19. An ISCI/SKU field 310-20 to enter and/or display an ISCI/SKU.
20. A graphic/image field 310-21 that indicates if there is a graphic image available for the packaging of a CD volume or for inclusion with a download of a volume.
21. A rendered logo field 310-22 to indicate or hold a logo for the compilation volume, such as for example a “gold logo” that is associated with a “gold volume” compilation.
22. A sponsor name field 310-23 that may be used to hold a sponsor name for the volume.
23. A sponsor logo field 310-24 that may be used to hold a sponsor logo, wherein the sponsor is for the volume.
24. An up button 310-25 that may be used to move a selected track up in the list of tracks.
25. A down button 310-26 that may be used to move a selected track down in the list of tracks.
26. A remove button 310-27 that may be used to remove a track from the list of tracks.
27. A submit as final button 310-28 that may be used to submit the final version of the volume.

### According to one example embodiment, the audio files may be uploaded as a batch, or one at a time.

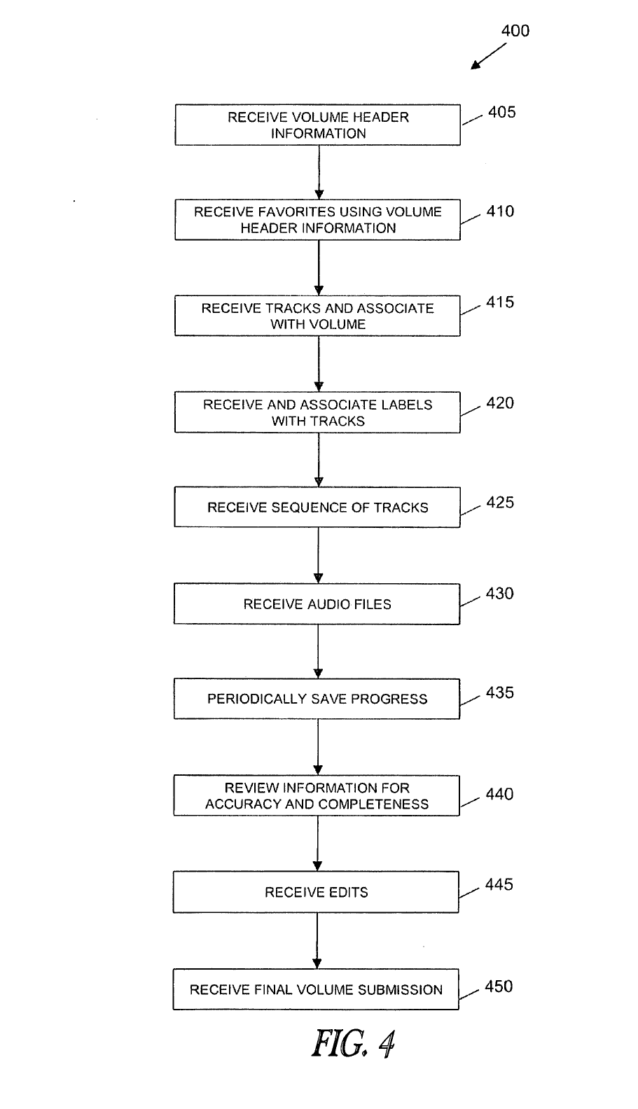

According to another example embodiment illustrated in FIG. 4, there is illustrated a method 400 for using the user interface of FIG. 2. First, the volume header information may be entered 405. The volume information field may be used 410 to call attention to favorite tracks and/or radio station events. Track rows may then be added 415 by pressing “add track” button. Labels (title & artist) may be added 420 to the tracks. The tracks are placed in proper sequence, and labels are added 425 as desired to appear on a track listing. Final-edit/produced audio files (.mp3 file format) are added 430 to corresponding track labels, or bulk uploaded. Updates may be saved 435 periodically by pressing “save progress” button. The entered information is reviewed 440 for accuracy: volume header, sequence, labeling and corresponding .mp3. Any final copy edits and/or track adjustments are made 445. The volume is submitted 450 as final. This submission indicates that the volume information is ready to be used to prepare CD's for shipment using provided tracks and information, or ready to be used to create a downloadable CD or other audio file.

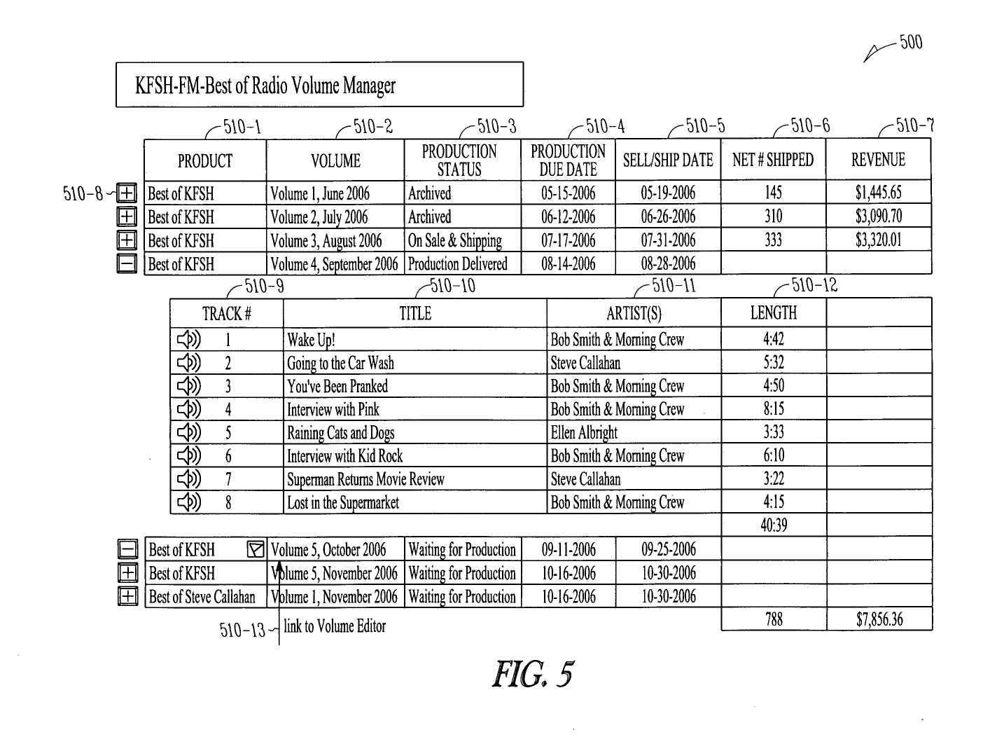

Referring now to FIG. 5, there is illustrated one example embodiment of a web-based user interface 500 supported by the server system 110, wherein the web-based interface is used to display products and related volumes and various related information. This interface may be used by a user, for example a user or agent of a radio station, to help manage and create products comprising compilations of audio tracks (or audiovisual as the case may be for other applications) that in this example are termed volumes for sale and distribution, and includes the following features:
1. A product field 510-1 to enter and/or display a product name.
2. A volume field 510-2 to enter and/or display a volume name or label.
3. A production status field 510-3 to enter and/or display a status of a future, current, or previously released compilation.
4. A production due date field 510-4 to enter and/or display a production due date.
5. A sell and ship dates field 510-5 to enter and/or display volume sell and ship dates.
6. A net # shipped field 510-6 to display the number of volumes shipped.
7. A revenue field 510-7 to display the net revenues from sales of the shipped volumes.
8. A expand or collapse button 510-8 that may be used to show or conceal detail concerning any of the volumes, wherein the detail includes the following information:
   a. A track number field 510-9 to display a track number.
   b. A track title field 510-10 to enter and/or display a track title.
   c. An artists field 510-11 to display artists associated with the track.
   d. A track length field 510-12 to display the length of a track, wherein the length of the track is determined by system 110 by inspecting the associated audio file uploaded for the track.
9. A hyperlink 510-13 for each volume name to use to open the volume editor user interface shown in FIG. 3.

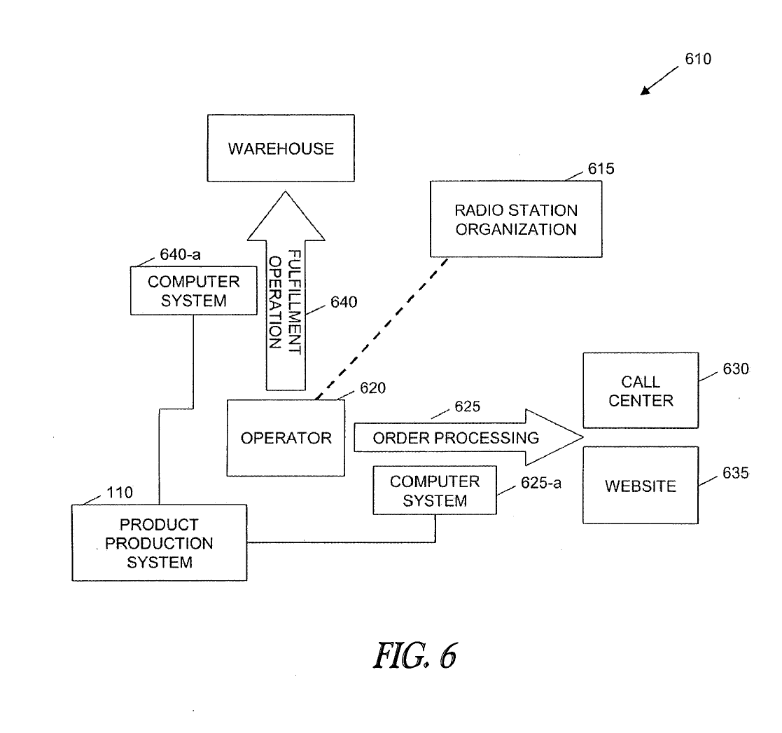

Referring now to FIG. 6, there is illustrated one example embodiment of a system user structure 610 for the system 110, wherein more than one radio station organization 615 (such as a single radio station or a cluster of commonly owned or operated radio stations) uses the system 110 on a shared basis, such that each radio station organization may be provided its own “account” on the system in order to create and manage content for sale and distribution, and where a system sponsor or operator 620 provides access to the radio station organizations 615 either for a fee or on another basis. According to one example embodiment, operator 620 further provides an order processing operation 625 (owned or contracted with, for example) that may include a call center 630 to receive calls or e-mails seeking to order the products, for example volumes/compilations, produced using the system, or a web site 635 that can be used to order the products. Operator 620 may further provide a fulfillment operation 640 (on an owned or contract basis for example) that can be used to produce ordered products and ship them to customers. The order processing operation 625 includes an order processing computer system 625-a to support ordering of the products, wherein the system 625-a may be directly connected or be provided information on the current products/volumes so that the users in the order processing operation know what volumes are available to sell on a real-time or near real-time basis, or at least know that the available volumes are current as of a particular date or time lag from being posted as available for sale by those producing them. In an embodiment, order processing at the call center 630 may be semi or fully automated, for example by using an automated interactive voice response system (IVRS) or other voice recognition systems. In a further embodiment, some calls or some portion of calls may be handled by a live operator while other calls or other portions of calls may be handled by an IVRS. For example, when inbound calls are considered too numerous such that hold times are over a threshold period, then automatic IVRS systems may be implemented to handle some or all of the caller's questions or to take an order from the caller.

According to another example embodiment, the fulfillment operation 640 has a fulfillment computer system 640-a that receives orders from the order processing operation computer system 625-a and is connected or has access to the data in the product production system 110, in order to access the volume information needed to produce a CD, including the packaging information. In one embodiment, production includes burning a CD and printing the CD cover and liner.

In an alternate embodiment, a single computer system or software system may be used to support the functions of creation and production of the products for sale, order processing and fulfillment, or any combination of computer systems or software systems. In other words, the exact configuration of the computing systems or supporting software is not important to the operation of the inventive subject matter.

According to still another example embodiment, the order processing computer system 625-a or fulfillment software 640-a includes software and interfaces to facilitate, for example but not by way of limitation, the following types of orders and billing arrangements:
1. An order for a single volume that is paid for by credit card or by other electronic payment arrangement, or by paper billing.
2. An order for an entire series of volumes, for example the “best of” for an entire year, either for a prior year or the current year, that is paid for in advance or as the volumes are produced.
3. Tracking orders for a series for which volumes are newly added on an ongoing basis such that the newly added volumes are produced and shipped when they become available.

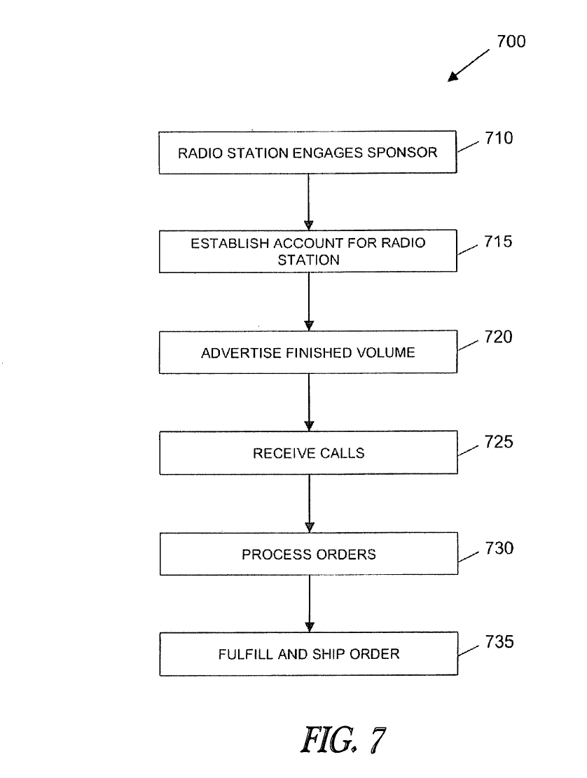

Referring now to FIG. 7, there is illustrated one embodiment of a method and system 700 for producing and distributing content, for example a “best of” series for a radio station organization. However, while the system and method are described in this example embodiment for producing a “best of” series, the system and method may be used to produce and distribute any type of compilation. For example, a limited edition, “one off,” or special edition may be provided that includes the best of a particular genre of entertainment, but the edition is not necessarily periodic or repeated. Returning to the description of the “best of” example embodiment, the “best of” series is a way for a radio station organization to promote its station(s), programs and personalities by giving the listeners the best of the station's content from every month or other period, such a quarters or years or decades, for example. Such content may include interviews, live performances, crazy callers, or exclusive material that never aired. According to this embodiment, an operator or other sponsoring party (such as party 620) provides the system for producing the “best of” series (for example system 110) and the order processing operations (for example operations 625) and fulfillment operations (for example fulfillment operations 640). In this system and method, the radio station organizations engage 710 the sponsoring party to provide access to the production, ordering and fulfillment systems and operations. An account is established 715 in system 110 to support each radio station organization, such that the radio station organization may use the system 110 to produce products, for example volumes of audio content, as described above.

In one embodiment, a volume is produced each month by the radio station organization, by logging into their own account on system 110 and following the required process. Once the volume is marked ready for shipment, the radio station organization may promote it on-air (or it may be promoted before it is ready) or otherwise advertise 720 the volume or other previous volumes or products. According to one embodiment, promotional materials are provided by the operating party 620 for use by the radio station organization to promote the “best of” products. Phone numbers for radio station listeners to call may be provided by the operating party 620, and calls to the number of numbers are received and processed 725 and orders are taken 730. The orders are communicated to the fulfillment center that in turns produces and ships 735, or at least ships in the even the product has been stocked, the product to the customer. A share of revenue or other payment or compensation is then paid to the radio station organization by the operating party 620, based on sales of the content sold, or based on other arrangements to provide a financial incentive for the operating party 620.

According to one example embodiment, a suite of marketing tools provided to the radio station organization by the operating party are designed to integrate seamlessly into the station's routine. These materials may include print, broadcast and internet promotion materials and a dedicated phone number for your station for ordering product. According to still another example embodiment, the CD's may be collector quality. In another embodiment, if a customer orders an entire series, they receive a case for the collection (for example free) that is of perceived high quality to the user. Such a case may be made of paper or plastic and serve as a container for all the CDs in the series.

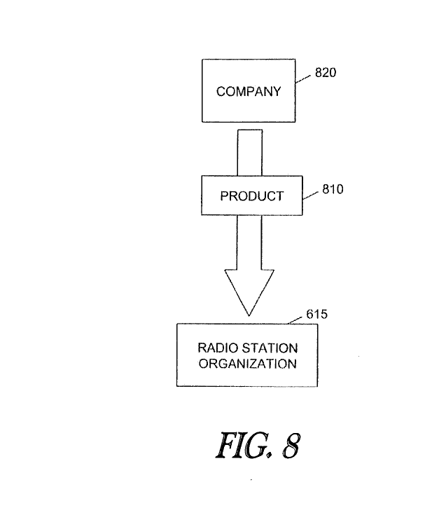

Thus, according to one example embodiment, the radio station organization chooses the audio for the station's “best of” series. The promotional materials are used to generate listener interest. Orders are handled by the operating party, which also handles manufacturing the CDs (or downloads) and the shipping of the CDs to the customers. In an embodiment, orders may be fulfilled using digital media, such as with a downloadable format (e.g., .mp3 or .wav files over the Internet). For example, a user may order a series to be delivered via handheld device (e.g., iPod, cellular telephone, Blackberry). As another example, the user may be granted access to a download site (e.g., FTP server or secured website) after paying for the order. The radio station organization may also then be entitled to payment for sales made by the operating party. According to this process, the station's content is leveraged for more revenue. In addition, the station organization has additional flexibility in choosing the content to distribute, may gain additional monthly revenue with minimal time and resources, and may obtain a potentially deeper connection to its listeners. In addition, according to one example embodiment, as illustrated in FIG. 8, the “best of” series product 810 may be sponsored by other companies 820 that pay a sponsorship fee to the radio station organization, bringing in additional revenue.

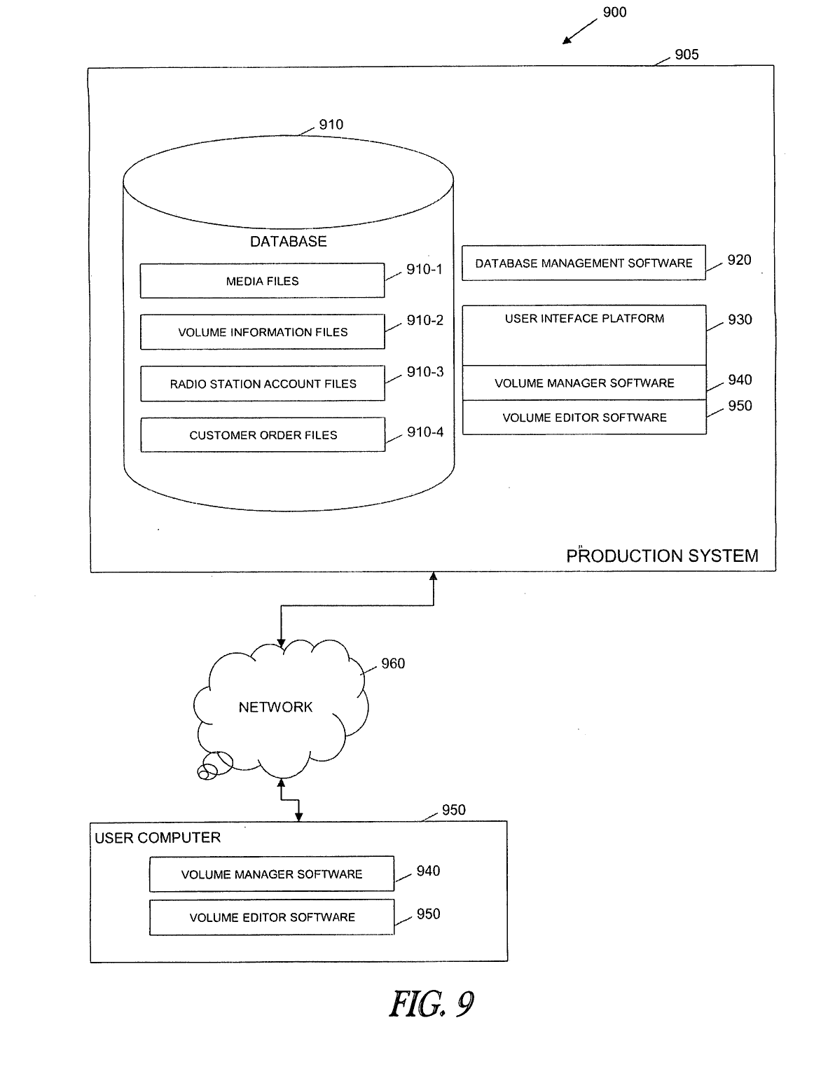

Referring now to FIG. 9, there is illustrated one embodiment of system 900 for producing and distributing content, for example a “best of” series for a radio station organization. However, while the system and method are described in this example embodiment for producing a “best of” series, the system and method may be used to produce and distribute any type of compilation. A production system 905 (e.g., content server system 110 of FIG. 1) may comprise a database 910. The database may be a relational database, flat file database, object oriented database, or other type of data storage mechanism to store media files (e.g., sound or video files), textual information, accounting information, and the like. In this example, database 910 includes media files 910-1, volume information files 910-2, radio station account files 910-3, and customer order files 910-4. Media files 910-1 may include audio, video, or other multimedia files. In an embodiment, media files 910-1 includes links to locations of media files, such as on a file server or other networked location. Volume information files 910-2 includes track names and ID's that comprise a volume. In addition, volume information files 910-2 may include volume label, sequence information, total play length, production status, product due date, net # shipped, or other information related to managing volumes, such as illustrated in FIGS. 2, 3, and 5. Radio station account files 910-3 may include information of participating radio stations, such as contact name, radio station identifier, account balance, related volumes or tracks, user information for users of the system 905, or other information to describe, manage, or enable a radio station or a radio station cluster to access and interact with the system 905. Customer order files 910-4 may include customer information (e.g., name, shipping address, billing address) along with order information (e.g., volume information, recurrence type, payment details).

The production system 905 may further include a database management software 920 to perform sorting, indexing, or other data optimizations or maintenance on the database 910. The database management software 920 may also provide an interface to the database 910 from a user interface platform 930. The user interface platform 910 may include one or more software components, such as a volume manager software 940 or volume editor software 950, examples of which are illustrated in FIG. 5 and FIG. 3, respectively. The user interface platform 910 may also include scripts, library files, executable files, or other software or hardware components to provide file access, database access, or control access to the production system 905 or the database 910.

One or more user computers 950 may connect to the he production system 905 over a network 960. User computers 950 may be located at a radio station or at another location, such as a radio station cluster manager's office. In an embodiment, the user computer contains similar software as the production system 905, such as volume manager software 940 or volume editor software 950, to allow a radio station user to access and interact with the production system 905.

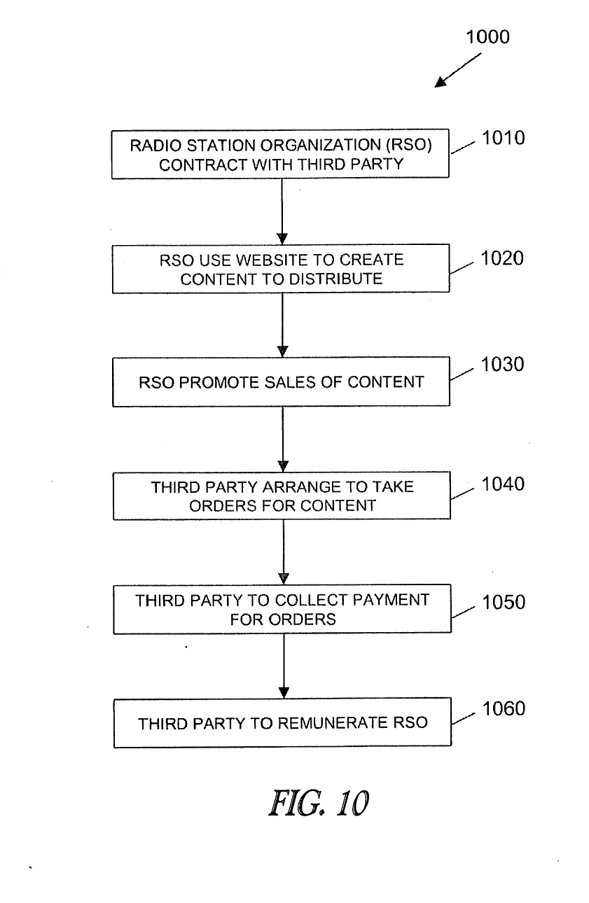

Referring now to FIG. 10, there is illustrated a method 1000 of coordinating the production and distribution of content between a radio station organization and a third party. A radio station organization (RSO) contracts 1010 with a third party to assist the RSO to create, store and distribute radio station content to customers. The RSO may use 1020 a web site made available by the third party to create content to distribute to customers. The RSO may arrange to promote 1030 the sale of the content created by the RSO using a radio station broadcast. In an embodiment, the third party may provide advertising materials to the RSO to be used to promote the sale of content. In such an embodiment, the content includes materials selected as being relatively better than other content generated by the RSO during a particular time period, or of special interest. The third party may then arrange 1040 for taking orders for and distributing content created by the RSO to customers. For example, the third party may provide a phone number to the RSO for the RSO's listeners to use to call in and order the content created by the RSO. The third party may then collect 1050 payment for the ordered content and remunerate 1060 the RSO at least a portion of the payment collected by the third party.

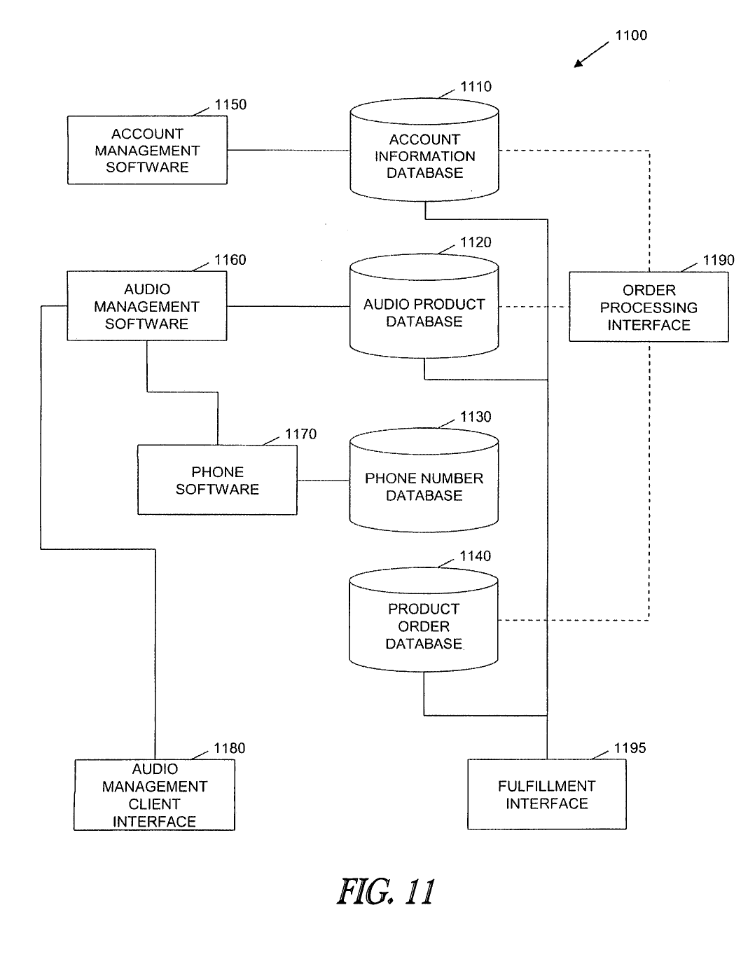

Referring now to FIG. 11, there is illustrated one embodiment of system 1100 for producing and distributing content, for example a “best of” series for a radio station organization. The system 1100 may include databases or other storage mechanisms, such as account information database 1110, audio product database 1120, phone number database 1130, or product order database 1140. Account management software 1150 may interface with account information database 1110 to enter new accounts or manage existing accounts, where accounts may represent a radio station or radio station cluster. Audio management software 1160 may interface with audio product database to upload, organize, label, edit, arrange, or otherwise manage audio tracks, files, or compilations. Phone software 1170 may interface with phone number database 1130, where the phone number database 1130 is configured to store phone numbers associated with a particular audio product or radio station organization. For example, a radio station may market a best of compilation and use a unique phone number to track and route inquiries related to the compilation. As another example, a phone number may be associated with one or more radio stations, such as at a common call center or order processing entity. Phone software 1170 may interface with the audio management software 1150 to determine inventory, availability, or other details related to the audio products in audio product database 1120. Phone software 1170 may also interface with account management software 1160 or account information database 1110 to determine a related radio station to a particular phone number.

Clients (e.g., radio station users or radio station cluster users) may interface with the audio management software 1150 using an audio management client interface 1180. Audio management client interface 1180 may have reduced functionality compared to audio management software 1150. Audio management client interface 1180 may be configured to allow a radio station organization user to load the audio tracks and related information into the audio product database.

Order processing interface 1190 may be provided to call center personnel or other order takers to give them an interface into the system 1100. Fulfillment interface 1195 may further be provided to obtain details about orders waiting to be fulfilled.

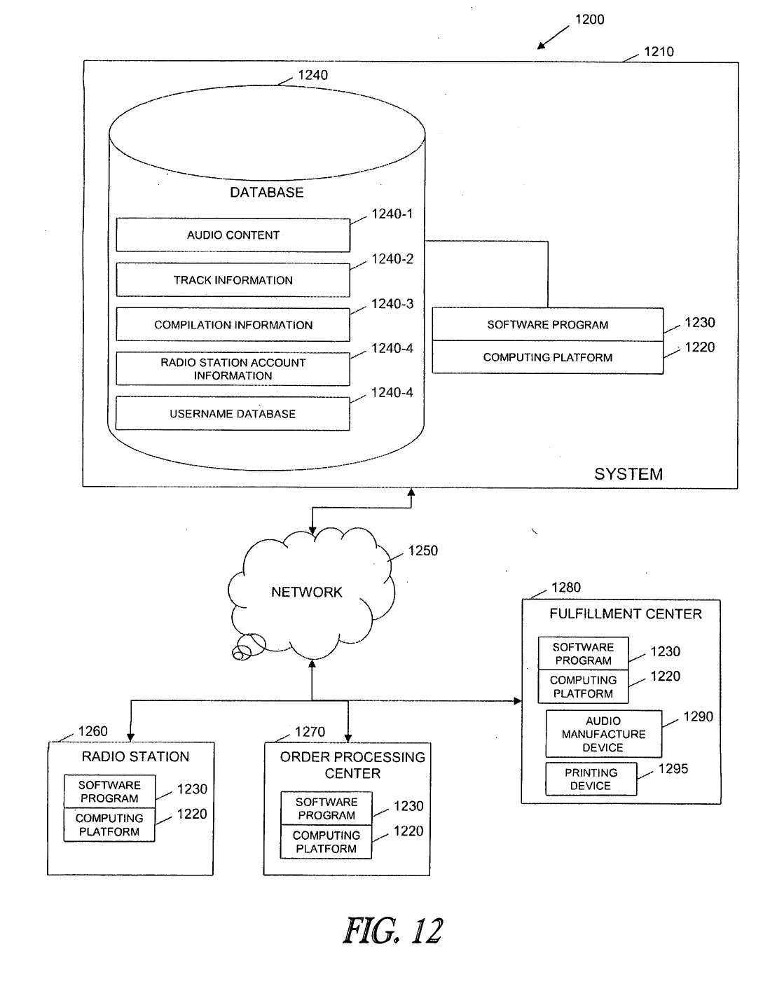

Referring now to FIG. 12, there is illustrated one embodiment of system 1200 for producing and distributing content, for example a “best of” series for a radio station organization. A computing system 1210 includes one or more computing platforms 1220, one or more software programs 1230 operative on the one or more computing platforms, and one or more data storage devices 1240 accessible by the computing platforms. In an embodiment, there are one or more data structures 1240-1, 1240-2, 1240-3, 1240-4 stored on the data storage devices 1240. One or more data structures 1240-1 are adapted to store and retrieve files including audio content and store and retrieve information associated with the audio content including track information and compilation information, wherein each compilation has associated therewith one or more tracks of audio content stored in the one or more data structures, and wherein each track includes a label for the track and wherein the compilation has a name. One or more data structures 1240-2 are further adapted to store a product name and to associate one or more compilations with the product name. One or more data structures 1240-3 are further adapted to store an identification for each of a plurality of radio station organizations, and at least one association between one or more of the products and an account of at least one of the radio station organizations. One or more data structures 1240-4 are further adapted to store at least one radio station user name and password associated with at least one of the radio station organizations. One or more data structures 1240-5 are further adapted to store one or more operating entity user names and passwords for an operating entity that is independent of the radio station organization.

The one or more software programs 1230 may be adapted to allow a user with one of the operating entity user names and passwords to access the data structures 1240 from a client computer over a wide-area network 1250 to provision user names and passwords for the radio station organizations and provision the accounts for the radio station organizations.

The one or more software programs 1230 may be adapted to allow a user with a radio station organization 1260 user name and password to access the one or more data structures 1240 from a client computer over a wide-area network 1250 to add audio content to the data structure 1240-1 and to organize the audio content into compilations and associate compilations with a product identified in the data structure 1240-1 as associated with the radio station organization associated with the user.

The one or more software programs 1230 may be adapted to provide a user interface for order processing center 1270 operators to allow the order processing center operators to access information in the data structure 1240 to process orders for products specified in the data structure, wherein the one or more data structures 1240 are further adapted to store order information including the name of a person or organization placing an order and shipping information associated therewith.

The one or more software programs 1230 may be adapted to provide fulfillment center 1280 personnel a user interface to access information in the data structure 1240 to download product information to the one or more devices 1290 used to manufacture audio products to fulfill one of the orders for an audio product. In addition, fulfillment center 1280 may include one or more devices 1290 used to manufacture an audio product or one or more printing devices 1295 used to manufacture shipping labels. The one or more software programs 1230 may be further adapted to provide shipping information taken from the one or more data structures to the one or more printing devices.

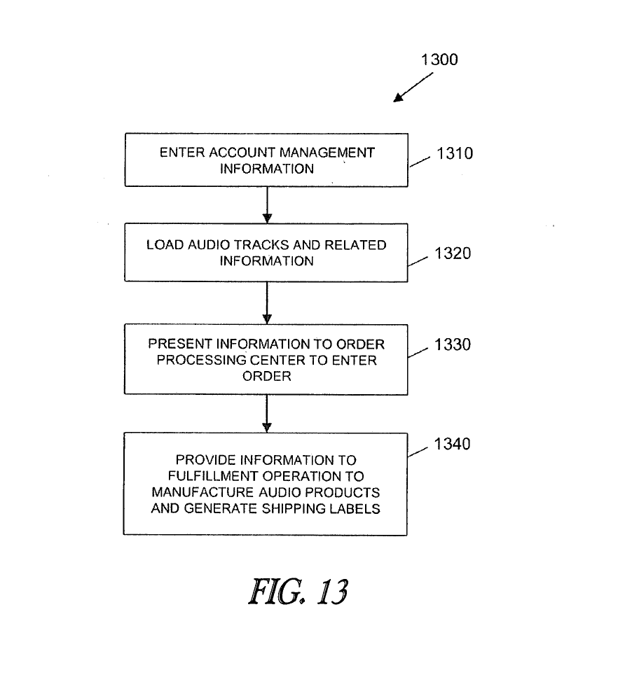

Referring now to FIG. 13, there is illustrated one embodiment of a method 1300 for producing and distributing content, for example a “best of” series for a radio station organization. An operating entity user may use an administrative data structure to enter 1310 account management information associated with accounts provisioned to a respective plurality of radio station organizations. In an embodiment, the account management information includes access rights and privileges for one or more radio station organization users associated with the radio station organizations. In a further embodiment, the operating entity user provisions accounts for each of the plurality of radio station organizations. A radio station organization user loads 1320 audio tracks and related information into an audio product data structure holding information associated with a plurality of audio products. In an embodiment, at least one audio product includes at least one compilation of audio files including audio content and information associated with the audio files, wherein each compilation is associated with at least one of the accounts. A computer program recognizing an origination identifier stored in an origination identifier data structure and identifying a radio station organization associated with the origination identifier. An order processing center operator is presented 1330 the name of a radio station organization associated with the origination identifier associated with the customer seeking to order an audio product, and the order processing center operator entering order information into a product order data structure holding product order information specifying orders for audio products specified in the audio product data structure, wherein the product order information stored in the data structure includes an identification of one of the audio products and a name and address for a customer ordering one of the audio products. A fulfillment operation responsible for fulfilling orders for the audio products is provided 1340 information required to manufacture audio products and to generate shipping labels for the audio products. In an embodiment, the order center operators and fulfillment operation are enabled to take and fulfill orders for audio products created by a plurality of different radio station organizations.

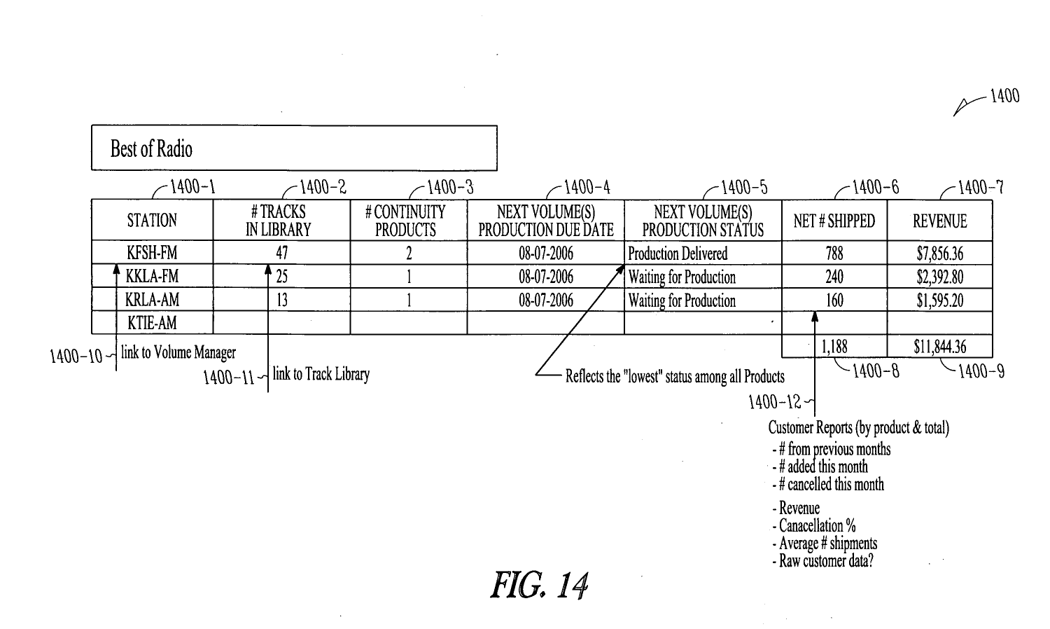

Referring now to FIG. 14, there is illustrated one example embodiment of a web-based user interface 1400 supported by the server system 110, wherein the web-based interface is used to display a high-level, multi-station view of products and related volumes and related information. This interface may be used by a user, for example a station manager or station cluster manager, to help manage and create products comprising compilations of audio tracks (or audiovisual as the case may be for other applications) across several stations and includes the following features:
1. A station field 1400-1 to enter and/or display a station identifier.
2. A # tracks in library field 1400-2 to enter and/or display a number of tracks in a library associated with the particular station.
3. A # continuity products field 1400-3 to enter and/or display a number of products in a series of related products, such as “volume 1,” “volume 2,” etc.
4. A next volume product due date field 1400-4 to enter and/or display a production due date
5. A production status field 1400-5 to enter and/or display a status of a future, current, or previously released compilation.
6. A net # shipped field 1400-6 to display the number of volumes shipped.
7. A revenue field 1400-7 to display the net revenues from sales of the shipped volumes.
8. A total shipped field 1400-8 to display the total number of volumes shipped.
9. A total revenue field 1400-9 to display the total net revenues from sales of the shipped volumes.
10. A hyperlink 1400-10 for each station identifier to open the volume manager user interface shown in FIG. 5.
11. A hyperlink 1400-11 for each track library to open the track library user interface shown in FIG. 2.
12. A hyperlink 1400-10 for each net number shipped to open a customer report user interface. The customer report user interface may include information such as a breakdown of sales by day, week, month, quarter, or year; a number of canceled or returned orders; an average number shipped per time period; or other data used to track, manage, sort, or organize sales data.

In an embodiment, a station manager or cluster manager may log into the system and view one or more products for one or more stations, for example, by using a user interface such as shown in FIG. 14 or FIG. 5. In embodiments, a cluster manager may have higher or broader access rights compared to a station manager, such that the cluster manager may have access to an interface as illustrated in FIG. 14, while a station manager may only have access to an interface as illustrated in FIG. 5. In an embodiment, a high-level, multi-station view, such as the one illustrated in FIG. 14, may be advantageous to a cluster manager in providing access to stations under his control in one user interface. The high-level, multi-station view may be incorporated into other user interfaces in various embodiments, such as user interfaces to manage one or more stations' programming, advertising slots, or finances.

It is to be understood that the above description is intended to be illustrative and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

For the purposes of this specification, the term “machine-readable medium” or “computer-readable medium” shall be taken to include any medium which is capable of storing or encoding a sequence of instructions for execution by the machine and that cause the machine to perform any one of the methodologies of the inventive subject matter. The terms “machine-readable medium” or “computer-readable medium” shall accordingly be taken to include, but not be limited to, solid-state memories, optical and magnetic disks, and carrier wave signals. Further, it will be appreciated that the software could be distributed across multiple machines or storage media, which may include the machine-readable medium.

Method embodiments described herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer-readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The foregoing description of specific embodiments reveals the general nature of the inventive subject matter sufficiently that others can, by applying current knowledge, readily modify and/or adapt it for various applications without departing from the generic concept. Therefore, such adaptations and modifications are within the meaning and range of equivalents of the disclosed embodiments. The phraseology or terminology employed herein is for the purpose of description and not of limitation. Accordingly, the inventive subject matter embraces all such alternatives, modifications, equivalents, and variations as fall within the spirit and broad scope of the appended claims.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

1. A system comprising:
an administrative data structure to hold account management information associated with accounts provisioned to a respective plurality of radio station organizations, wherein the account management information includes access rights and privileges for one or more radio station organization users associated with the radio station organizations;
at least one client interface adapted to allow a user associated with an operating entity to enter and modify account management information to provision accounts for the plurality of radio station organizations;
an audio product data structure to hold information associated with a plurality of audio products, wherein at least one audio product includes at least one compilation of audio files including audio content and information associated with the audio files, wherein each compilation is associated with at least one of the accounts;
at least one client interface adapted to allow a radio station organization user to load the audio tracks and related information into the audio product data structure;
a phone number data structure to hold phone numbers associated with a plurality of radio station organizations;
at least computer program to recognize one of the phone numbers stored in the phone number data structure and to identify a radio station organization associated with the phone number;
a product order data structure to hold product order information specifying orders for audio products specified in the audio product data structure, wherein the product order information stored in the data structure includes an identification of one of the audio products and a name and address for a customer ordering one of the audio products;
at least one client interface adapted to display to an order processing center operator a radio station organization associated with a phone number called by the customer seeking to order an audio product, and to allow an order processing center operator to enter order information into the product order data structure;
at least one client interface adapted to enable fulfillment personnel responsible for fulfilling orders for the audio products to manufacture audio products and to generate shipping labels for the audio products; and
wherein the order center operators and fulfillment personnel are enabled to take and fulfill orders for audio products created by a plurality of different radio station organizations.

2. A system comprising:
an administrative data structure to hold account management information associated with accounts provisioned to a respective plurality of radio station organizations, wherein the account management information includes access rights and privileges for one or more radio station organization users associated with the radio station organizations;
at least one client interface adapted to allow a user associated with an operating entity to enter and modify account management information to provision accounts for the plurality of radio station organizations;
an audio product data structure to hold information associated with a plurality of audio products, wherein at least one audio product includes at least one compilation of audio files including audio content and information associated with the audio files, wherein each compilation is associated with at least one of the accounts;
at least one client interface adapted to allow a radio station organization user to load the audio tracks and related information into the audio product data structure;
an origination information data structure to hold origination information associated with a web location of each of a plurality of radio station organizations usable to identify the network origin of a user arriving at a web server;
at least computer program to recognize origination information with reference to the origination information stored in the origination information database and to identify a radio station organization associated with the origination information;
an product order data structure to hold product order information specifying orders for audio products specified in the audio product data structure, wherein the product order information stored in the data structure includes an identification of one of the audio products and a name and address for a customer ordering one of the audio products;
at least one client interface adapted to display to an order processing center operator a radio station organization associated with a web location visited by the customer seeking to order an audio product, and to allow an order processing center operator to enter order information into the product order data structure;
at least one client interface adapted to enable fulfillment personnel responsible for fulfilling orders for the audio products to manufacture audio products and to generate shipping labels for the audio products; and
wherein the order center operators and fulfillment personnel are enabled to take and fulfill orders for audio products created by a plurality of different radio station organizations.

3. A system comprising:
a computing system including one or more computing platforms, one or more software programs operative on the one or more computing platforms, and one or more data storage devices accessible by the computing platforms;
one or more data structures stored on the data storage devices, wherein the one or more data structures are adapted to store and retrieve files including audio content and store and retrieve information associated with the audio content including track information and compilation information, wherein each compilation has associated therewith one or more tracks of audio content stored in the one or more data structures, and wherein each track includes a label for the track and wherein the compilation has a name, the one or more data structures further adapted to store a product name and to associate one or more compilations with the product name, the one or more data structures further adapted to store an identification for each of a plurality of radio station organizations, and at least one association between one or more of the products and an account of at least one of the radio station organizations, the one or more data structures further including at least one radio station user name and password associated with at least one of the radio station organizations, the one or more data structures further adapted to store one or more operating entity user names and passwords for an operating entity that is independent of the radio station organization;
the one or more software programs adapted to allow a user with one of the operating entity user names and passwords to access the data structure from a client computer over a wide-area network to provision user names and passwords for the radio station organizations and provision the accounts for the radio station organizations;
the one or more software programs adapted to allow a user with a radio station organization user name and password to access the one or more data structures from a client computer over a wide-area network to add audio content to the data structure and to organize the audio content into compilations and associate compilations with a product identified in the data structure as associated with the radio station organization associated with the user;
the one or more software programs adapted to provide a user interface for order processing center operators to allow the order processing center operators to access information in the data structure to process orders for products specified in the data structure, wherein the one or more data structures are further adapted to store order information including the name of a person or organization placing an order and shipping information associated therewith;
one or more devices used to manufacture an audio product;
the one or more software programs adapted to provide fulfillment personnel a user interface to access information in the data structure to download product information to the one or more devices used to manufacture audio products to fulfill one of the orders for an audio product;
one or more printing devices used to manufacture shipping labels; and
the one or more software programs adapted to provide shipping information taken from the one or more data structures to the one or more printing devices.

4. A system comprising:
a computing system including one or more computing platforms, one or more software programs operative on the one or more computing platforms, and one or more data storage devices accessible by the computing platforms;
one or more data structures stored on the data storage devices, wherein the one or more data structures are adapted to store and retrieve files including audio content and store and retrieve information associated with the audio content including track information and compilation information, wherein each compilation has associated therewith one or more tracks of audio content stored in the one or more data structures, and wherein each track includes a label for the track and wherein the compilation has a name, the one or more data structures further adapted to store a product name and to associate one or more compilations with the product name, the one or more data structures further adapted to store an identification for each of a plurality of radio station organizations, and at least one association between one or more of the products and an account of at least one of the radio station organizations, the one or more data structures further including at least one radio station user name and password associated with at least one of the radio station organizations, the one or more data structures further adapted to store one or more operating entity user names and passwords for an operating entity that is independent of the radio station organization;
the one or more software programs adapted to allow a user with one of the operating entity user names and passwords to access the data structure from a client computer over a wide-area network to provision user names and passwords for the radio station organizations and provision the accounts for the radio station organizations;
the one or more software programs adapted to allow a user with a radio station organization user name and password to access the one or more data structures from a client computer over a wide-area network to add audio content to the data structure and to organize the audio content into compilations and associate compilations with a product identified in the data structure as associated with the radio station organization associated with the user;
the one or more software programs adapted to provide access to information in the data structure to one or more users responsible for processing orders for products specified in the data structure; and
the one or more software programs adapted to provide access to information in the data structure to one or more users responsible for manufacturing an audio product to fulfill one of the orders for an audio product.

5. A method comprising:
an operating entity user using an administrative data structure to enter account management information associated with accounts provisioned to a respective plurality of radio station organizations, wherein the account management information includes access rights and privileges for one or more radio station organization users associated with the radio station organizations, wherein the operating entity user provisions accounts for each of the plurality of radio station organizations;
a radio station organization user loading audio tracks and related information into an audio product data structure holding information associated with a plurality of audio products, wherein at least one audio product includes at least one compilation of audio files including audio content and information associated with the audio files, wherein each compilation is associated with at least one of the accounts;
a computer program recognizing an ordination identifier stored in an origination identifier data structure and identifying a radio station organization associated with the origination identifier;
presenting to an order processing center operator the name of a radio station organization associated with the origination identifier associated with the customer seeking to order an audio product, and the order processing center operator entering order information into a product order data structure holding product order information specifying orders for audio products specified in the audio product data structure, wherein the product order information stored in the data structure includes an identification of one of the audio products and a name and address for a customer ordering one of the audio products;
providing to a fulfillment operation responsible for fulfilling orders for the audio products information required to manufacture audio products and to generate shipping labels for the audio products; and
wherein the order center operators and fulfillment operation are enabled to take and fulfill orders for audio products created by a plurality of different radio station organizations.
